(19) United States
(12) Patent Application Publication
(10) Pub. No.: US 2023/0410611 A1
(43) Pub. Date: Dec. 21, 2023

(54) LOTTERY TICKET CONTRACT SYSTEM AND SERVICE

(71) Applicant: Christopher Govrik, Mendota Heights, MN (US)

(72) Inventor: Christopher Govrik, Mendota Heights, MN (US)

(21) Appl. No.: 18/212,058

(22) Filed: Jun. 20, 2023

Related U.S. Application Data
(60) Provisional application No. 63/353,594, filed on Jun. 19, 2022.

(51) Int. Cl. G07F 17/32

(52) U.S. Cl. CPC G07F 17/329; G07F 17/3244

(57) ABSTRACT

Embodiments herein relate to a system and method for distributing lottery proceeds. In an embodiment, a method for distributing lottery proceeds, the method is included, the method creating an agreed upon lottery proceeds distribution protocol for dividing lottery proceeds between an organizer and a participant; identification of an organizer; identification of an organizer purchasing at least one lottery ticket in advance of a lottery drawing; determining if the lottery ticket has been a winner and the amount of the lottery proceeds; and distributing the lottery proceeds based upon the distribution protocol; wherein the participant receives a pre-determined portion of the lottery proceeds.

This application claims the benefit of U.S. Provisional Application No. 63/353,594, filed Jun. 19, 2022, the content of which is herein incorporated by reference in its entirety.

### SUMMARY

The present disclosure is directed, in part, to a contract system and service for participation in lotteries. In an example embodiment the contracts are between two or more people or entities, at least one of whom is located in a state or jurisdiction that offers the purchase of lottery tickets, and another person or entity who is not located in that state or jurisdiction.

The contract system typically relies on people or entities referred to herein as organizers and participants. An organizer is located in the state where the lottery draw game occurs, and the organizer can legally procure that state's lottery draw game ticket or tickets. The participant is located in a different jurisdiction where they do not have access to purchase the lottery tickets from the organizer's state. The contract system provides access for participants to participate in the lottery draw game no matter their location. In particular, the contract system allows for participants to participate in lottery draw games that they would not otherwise be able to participate in by having the organizer purchase the tickets in accordance with a contract between the organizer and participant.

The contract system and method provides some of the following functionality in different embodiments (without limitation):

In a first aspect, the system and method defines the division of lottery proceeds between the organizer and participant.

In a second aspect, the system provides for a monetary contribution by each of the organizer and participant to the purchase of lottery tickets. The monetary contribution between the organizer and participant solidifies the contractual agreement between the parties with consideration. This contract creates access for the participant to lawfully participate in the lottery draw games from any location where lottery draw games are allowed (and where an organizer is present).

A third aspect of the system is to legally procure the lottery tickets either electronically (if the jurisdiction allows for that) or in-person for the organizer and participant. The system and method provide a means for securing the ticket and dividing the proceeds.

In an example non-limiting embodiment, for a $1.00 lottery ticket the organizer contributes $0.01 or 1% of the lottery ticket purchase price, while the participant contributes $0.99 or 99% of the ticket price. This financial contribution by each of the parties allows the participant access to the lottery draw games where otherwise they would have no access. Generally, when percentages are used for calculation the organizer will pay the lower cost or percent of the purchase price and the participant will pay the higher cost or percent.

The organizer can procure the lottery ticket directly or utilize a third party to procure the lottery ticket.

The contract between the organizer and participant is generally entered in electronically (such as through a phone app) rather than by paper.

The organizer can obtain the lottery ticket digitally or in-person in various embodiments.

In some implementations the division or proceeds are zero percent for the organizer and one hundred percent for the participant no matter the monetary contribution of each. Two private parties can agree to purchase a lottery ticket proportionally but also agree to divide the proceeds different than the split. Such embodiments can be used, for example, for promotional purposes.

In addition, in the United States there are currently some states that do not offer a lottery option. These states include millions of residents. The present contract system and service creates access for every one of those residents to play the lottery from any state. Even in states that do offer lotteries, they never offer all lotteries. Using the present contract system and service a participant can access any state lottery they choose through the contract system and service.

This access created by the system and method allows people from any state (or jurisdiction) to play the other state lotteries (and often larger states with more participants) such as New York, California, Florida, and Texas. For instance, most in-state lotteries have five-ball draw games that start at $100K and go up as far as $2M before they are usually won, and have relatively similar odds. An example of the totals for a particular week's draw are the following:
Florida five-ball: $1,860,000
Texas five-ball: $1,141,000
California five-ball: $932,000
New York five-ball: $770,000
   In contrast, if a person from Wisconsin was planning to play the Wisconsin five-ball for $1.00, the jackpot might be only $175,000 despite approximately the same odds as the larger five-ball games from the bigger states. Many more people play the large state lotteries because they are the populated states, however, the odds don't change for the players no matter how many people are buying that state lottery tickets. Such higher jackpots become available through the present contract system and method to even the Wisconsin (for example) resident.

Thus, the present disclosure is directed to a system and process for creating access to lottery draw games through a contract system.

It will be appreciated that in some embodiments the organizer and participant can be in the same state or jurisdiction where the lottery ticket is purchased. The participant may have reasons such as health concerns, mobility issues, or simply for convenience. Thus, the organizer and participant can be located in the same or different jurisdictions.

In an embodiment, a method for distributing lottery proceeds, the method is included, the method creating an agreed upon lottery proceeds distribution protocol for dividing lottery proceeds between an organizer and a participant, identification of an organizer, identification of a participant purchasing at least one lottery ticket in advance of a lottery drawing, determining if the lottery ticket has been a winner and the amount of the lottery proceeds, and distributing the lottery proceeds based upon the distribution protocol, wherein the participant receives a pre-determined portion of the lottery proceeds.

In an embodiment, the organizer receives a preset percent of the lottery proceeds.

In an embodiment, the participant receives a preset percent of all proceeds.

In an embodiment, the distribution is based upon the total size of the lottery proceeds.

In an embodiment, the organizer receives all proceeds below two dollars.

In an embodiment, the organizer receives all proceeds below three dollars.

In an embodiment, the organizer receives all proceeds below four dollars.

In an embodiment, the participant receives all proceeds above two dollars.

In an embodiment, the participant receives all proceeds above three dollars.

In an embodiment, the participant receives all proceeds above four dollars.

In an embodiment, a third-party beneficiary gets a portion of the lottery proceeds.

The third-party beneficiary can be, for example a person or other non-person entity (such as a non-profit).

In an embodiment, the third-party beneficiary gets all proceeds below a one-dollar amount.

In an embodiment, the third-party beneficiary gets all proceeds below a two-dollar amount.

In an embodiment, the third-party beneficiary gets all proceeds below a three-dollar amount.

In an embodiment, the third-party beneficiary gets all proceeds below a four-dollar amount.

In an embodiment, the third-party beneficiary is a non-profit organization.

In an embodiment, the third-party beneficiary recruits the participant.

In an embodiment, wherein multiple participants combine to purchase multiple lottery tickets.

In an embodiment, the lottery participants are from a single lottery jurisdiction.

In an embodiment, the lottery participants are from multiple lottery jurisdictions.

In an embodiment, wherein multiple lottery tickets are purchased, and the lottery tickets are from a single lottery jurisdiction.

In an embodiment, wherein multiple lottery tickets are purchased and the lottery tickets are from a multiple lottery jurisdictions.

In an embodiment, the lottery participants are from multiple lottery jurisdictions and the wherein the lottery tickets are from multiple lottery jurisdictions.

In an embodiment, the lottery is conducted with paper lottery tickets.

In an embodiment, the lottery is conducted with electronic lottery tickets.

In an embodiment, wherein multiple lottery tickets are purchased.

In an embodiment, the lottery tickets are from multiple lottery jurisdictions with different lottery games.

In an embodiment, the method can further include providing a report on an individual's lottery purchase.

In an embodiment, the method can further include charging an additional transaction fee.

In an embodiment, the purchase is from a state other than the state of residence of the participant.

In an embodiment, the purchase is from a state other than the state in which the participant is located.

In an embodiment, the purchase includes lottery tickets from a state in which the participant is located as well as from a state where the participant is not located.

In an embodiment, a method for distributing lottery proceeds, the method is included, the method creating an agreed upon lottery proceeds distribution protocol for dividing lottery proceeds between an organizer and a participant, identification of an organizer, identification of a third party beneficiary, identification of a participant, purchasing at least one lottery ticket in advance of a lottery drawing, determining if the lottery ticket has been a winner and the amount of the lottery proceeds, and distributing the lottery proceeds based upon the distribution protocol, wherein the third-party beneficiary receives a pre-determined portion of the lottery proceeds and the participant receives the remainder of the proceeds.

In an embodiment, the organizer receives a preset percent of the lottery proceeds.

In an embodiment, the participant receives a preset percent of all proceeds.

In an embodiment, the distribution is based upon the total size of the lottery proceeds.

In an embodiment, the third-party beneficiary receives all proceeds below two dollars.

In an embodiment, the third-party beneficiary receives all proceeds below three dollars.

In an embodiment, the third-party beneficiary receives all proceeds below four dollars.

In an embodiment, the participant receives all proceeds above two dollars.

In an embodiment, the participant receives all proceeds above three dollars.

In an embodiment, the participant receives all proceeds above four dollars.

In an embodiment, the third-party beneficiary recruits the participant.

In an embodiment, wherein multiple participants combine to purchase multiple lottery tickets.

In an embodiment, the lottery participants are from a single lottery jurisdiction.

In an embodiment, the lottery participants are from multiple lottery jurisdictions.

In an embodiment, wherein multiple lottery tickets are purchased, and the lottery tickets are from a single lottery jurisdiction.

In an embodiment, wherein multiple lottery tickets are purchased, and the lottery tickets are from a multiple lottery jurisdictions.

In an embodiment, the lottery participants are from multiple lottery jurisdictions and the wherein the lottery tickets are from multiple lottery jurisdictions.

In an embodiment, the lottery is conducted with paper lottery tickets.

In an embodiment, the lottery is conducted with electronic lottery tickets.

In an embodiment, wherein multiple lottery tickets are purchased.

In an embodiment, the lottery tickets are from multiple lottery jurisdictions with different lottery games.

In an embodiment, the method can further include providing a report on an individual's lottery purchase.

In an embodiment, the method can further include charging an additional transaction fee.

In an embodiment, the purchase is from a state other than the state of residence of the participant.

In an embodiment, the purchase is from a state other than the state in which the participant is located.

In an embodiment, a method for distributing lottery proceeds, the method is included, the method creating an agreed upon lottery proceeds distribution protocol for dividing lottery proceeds between an organizer and a participant, identification of an organizer, identification of at least one participant purchasing a plurality of lottery tickets in advance of a lottery drawing, determining if the lottery tickets include winner and the amount of the lottery proceeds, and distributing the lottery proceeds based upon the distribution protocol, wherein the participants receive a pre-determined portion of the lottery proceeds.

In an embodiment, the organizer receives a preset percent of the lottery proceeds.

In an embodiment, the participants receive a preset percent of all proceeds.

In an embodiment, the distribution is based upon the total size of the lottery proceeds.

In an embodiment, the organizer receives all proceeds below two dollars.

In an embodiment, the organizer receives all proceeds below three dollars.

In an embodiment, the organizer receives all proceeds below four dollars.

In an embodiment, the participants receive all proceeds above two dollars.

In an embodiment, the participants receive all proceeds above three dollars.

In an embodiment, the participants receives all proceed above four dollars.

In an embodiment, a third-party beneficiary gets a portion of the lottery proceeds.

In an embodiment, the third-party beneficiary gets all proceeds below a one dollar amount.

In an embodiment, the third-party beneficiary gets all proceeds below a two dollar amount.

In an embodiment, the third-party beneficiary gets all proceeds below a three dollar amount.

In an embodiment, the third-party beneficiary gets all proceeds below a four dollar amount.

In an embodiment, the third-party beneficiary is a non-profit organization.

The third-party beneficiary can also be, for example a person or other non-person entity (such as a non-profit).

In an embodiment, the third-party beneficiary recruits the participant.

In an embodiment, the lottery participants are from a single lottery jurisdiction.

In an embodiment, the lottery participants are from multiple lottery jurisdictions.

In an embodiment, wherein multiple lottery tickets are purchased, and the lottery tickets are from a single lottery jurisdiction.

In an embodiment, wherein multiple lottery tickets are purchased, and the lottery tickets are from multiple lottery jurisdictions.

In an embodiment, the lottery participants are from multiple lottery jurisdictions and the wherein the lottery tickets are from multiple lottery jurisdictions.

In an embodiment, the lottery is conducted with paper lottery tickets.

In an embodiment, the lottery is conducted with electronic lottery tickets.

In an embodiment, wherein multiple lottery tickets are purchased.

In an embodiment, the lottery tickets are from multiple lottery jurisdictions with different lottery games.

In an embodiment, the method can further include providing a report on an individual's lottery purchase.

In an embodiment, the method can further include charging an additional transaction fee.

In an embodiment, the purchase is from a state other than the state of residence of the participant. In certain embodiments the purchase is from a state in which the participant is located.

In an embodiment, the purchase is from a state other than the state in which the participant is located.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a map of the United States showing examples of variation in availability of lottery participation, including limitations based upon state, some of which are actual limitations and some of which are hypothetical limitations in view of the constant change in regulations and lottery options.

FIG. 2 is a map of the United States showing lottery participation options using the method and system of the current disclosure.

FIG. 3 is a map of the United States showing lottery participation options for an example implementation of the current disclosure.

FIG. 4 is a map of the United States showing lottery participation options for an example implementation of the current disclosure.

FIG. 5 is a map of the United States showing lottery participation options for an example implementation of the current disclosure.

FIG. 6 is a map of the United States showing lottery participation options for an example implementation of the current disclosure.

FIG. 7 is a map of the United States showing lottery participation options for an example implementation of the current disclosure.

FIG. 8 is an illustration showing an example lottery ticket, in this case a Powerball ticket.

FIG. 9 is an illustration showing an example lottery ticket, in this case a Powerball ticket, showing a first distribution option for lottery proceeds.

FIG. 10 is an illustration showing an example lottery ticket, in this case a Powerball ticket, showing a second distribution option for lottery proceeds.

FIG. 11 is an illustration showing an example lottery ticket, in this case a Powerball ticket, showing a third distribution option for lottery proceeds.

FIG. 12 is a schematic diagram showing elements of a system for distributing lottery proceeds in accordance with the present disclosure.

FIG. 13 is a flow chart showing example steps of a method for distributing lottery proceeds in accordance with the present disclosure.

FIG. 14 is a flow chart showing example steps of a method for distributing lottery proceeds in accordance with the present disclosure.

FIG. 15 is a flow chart showing example steps of a method for distributing lottery proceeds in accordance with the present disclosure.

FIG. 16 is a flow chart showing example steps of a method for distributing lottery proceeds in accordance with the present disclosure.

FIG. 17 is a flow chart showing example steps of a method for distributing lottery proceeds in accordance with the present disclosure.

FIG. 18 is a flow chart showing example steps of a method for distributing lottery proceeds in accordance with the present disclosure.

FIG. 19 is a flow chart showing example steps of a method for distributing lottery proceeds in accordance with the present disclosure.

FIG. 20 is a flow chart showing example steps of a method for distributing lottery proceeds in accordance with the present disclosure.

FIG. 21 is a flow chart showing example steps of a method for distributing lottery proceeds in accordance with the present disclosure.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Aspects may be better understood with reference to the following examples. These examples are intended to be representative of specific embodiments, but are not intended as limiting the overall scope of embodiments herein.

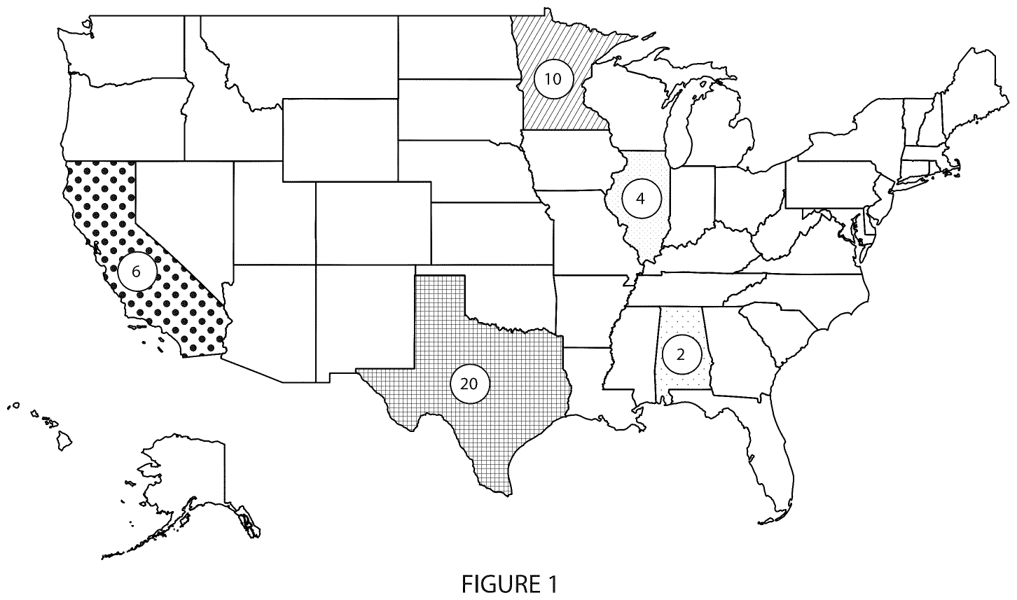

FIG. 1 is a map of the United States showing examples of variation in availability of lottery participation, including limitations based upon state, some of which are actual limitations and some of which are hypothetical limitations in view of the constant change in regulations and lottery options. For example, some states, such as Alabama 2 do not offer any lotteries at this time, while some states like Illinois 4 offer their own lottery, while states like California 6 do not currently offer mobile purchasing. The present system potentially allows people located in every one of these states, such as Minnesota or Texas 20 to participate in lotteries from around the country regardless of where the are located. In addition, a person can mix and match to participate in a combination of lotteries that would otherwise not be possible.

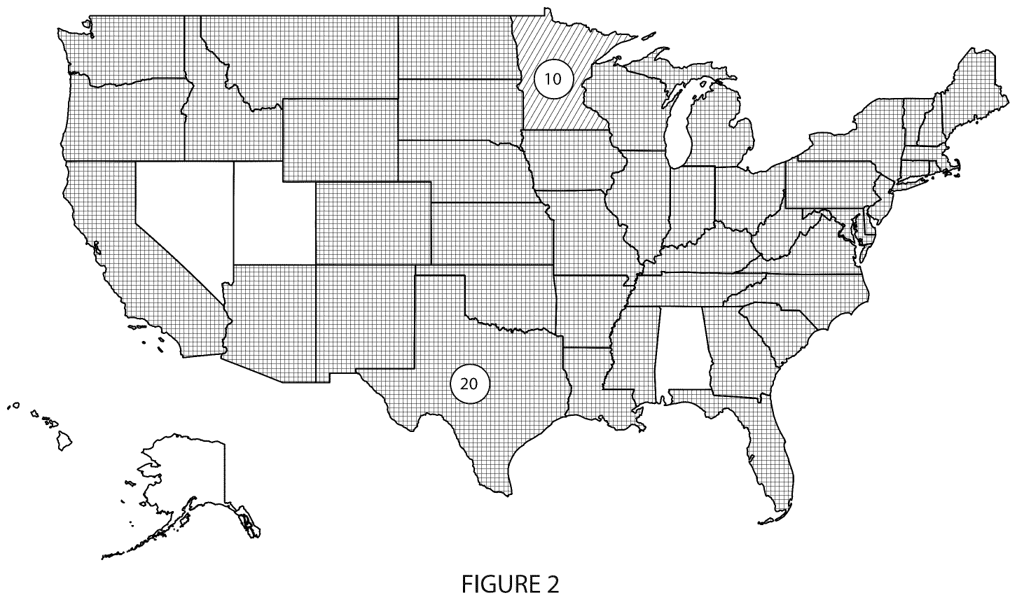

FIG. 2 is a map of the United States showing lottery participation options using the method and system of the current disclosure. In this aspect a person can be located in Minnesota 10 and purchase tickets from any other region 20 that offers a lottery (the white areas not offering in-state lotteries at the time of writing, so are not options for purchasing in-state lottery tickets since in-state lottery tickets are not offered to anyone (including residents of those states). Note, it will be appreciated that the rules and regulations change over time, and the examples shown herein are simply example embodiments, and that different combinations can be made and that possible combinations can change over time without deviating from the disclosure and claims herein.

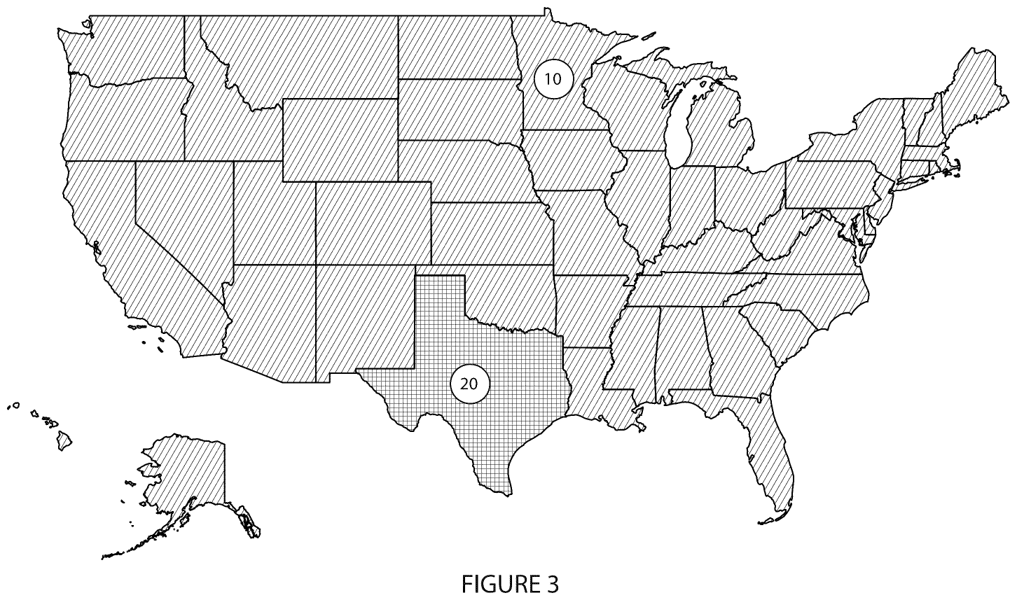

FIG. 3 is a map of the United States showing lottery participation options for an example implementation of the current disclosure in which participants from all regions can participate using lottery tickets purchased in Texas 20.

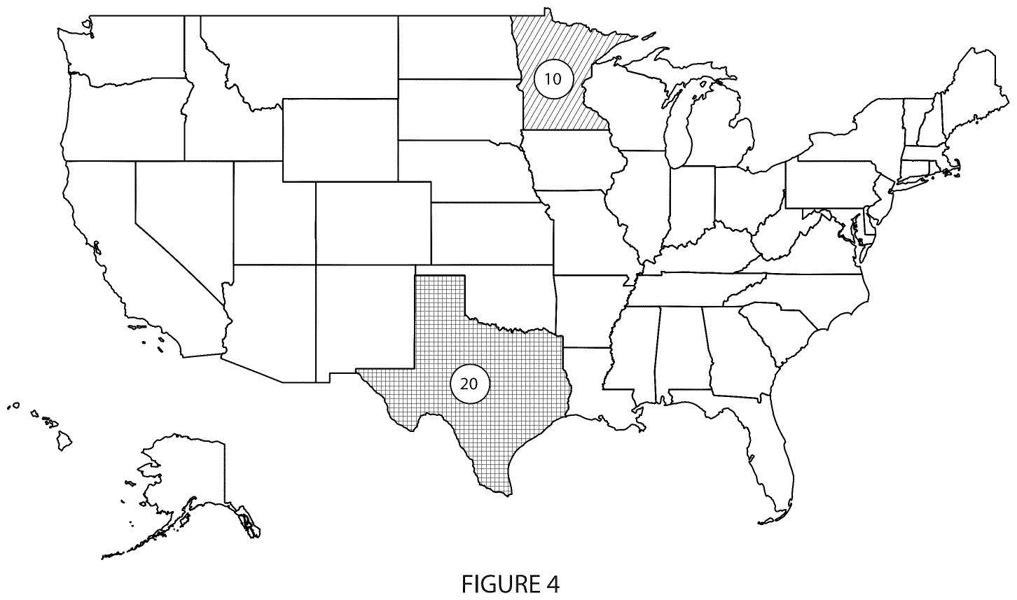

FIG. 4 is a map of the United States showing lottery participation options for an example implementation of the current disclosure in which a participant in Minnesota 10 can participate using tickets from the state of Texas 20.

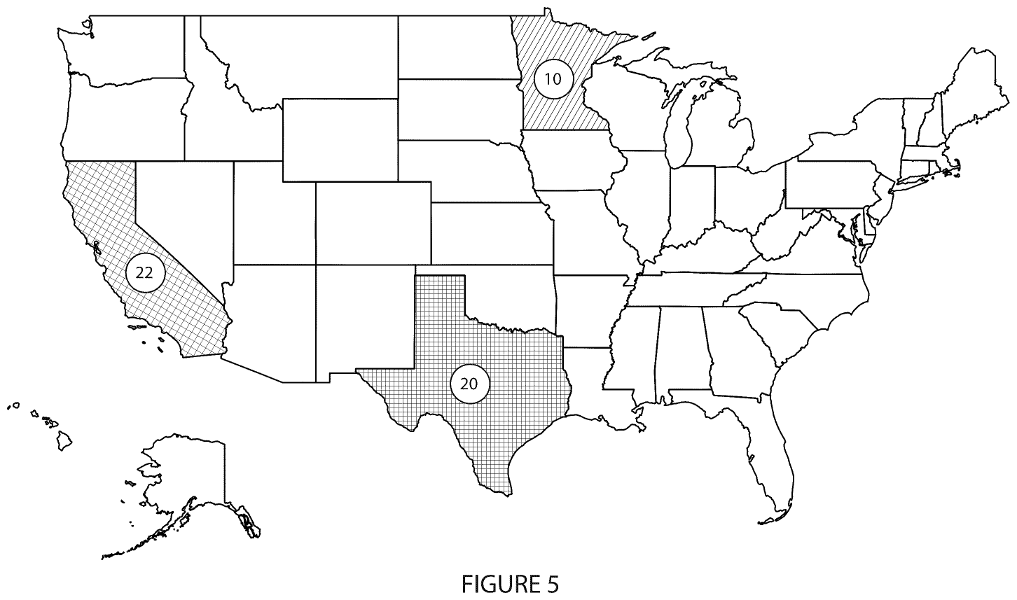

FIG. 5 is a map of the United States showing lottery participation options for an example implementation of the current disclosure in which a participant in the state of Minnesota 10 can participate using lottery tickets purchased from the state of Texas 20 or the state of California 22. Thus, the participant in Minnesota could participate with one (or more) one or more tickets from Texas and one (or more) lottery tickets from California. Typically there would be different organizers in the state of Texas 20 than the state of California 22.

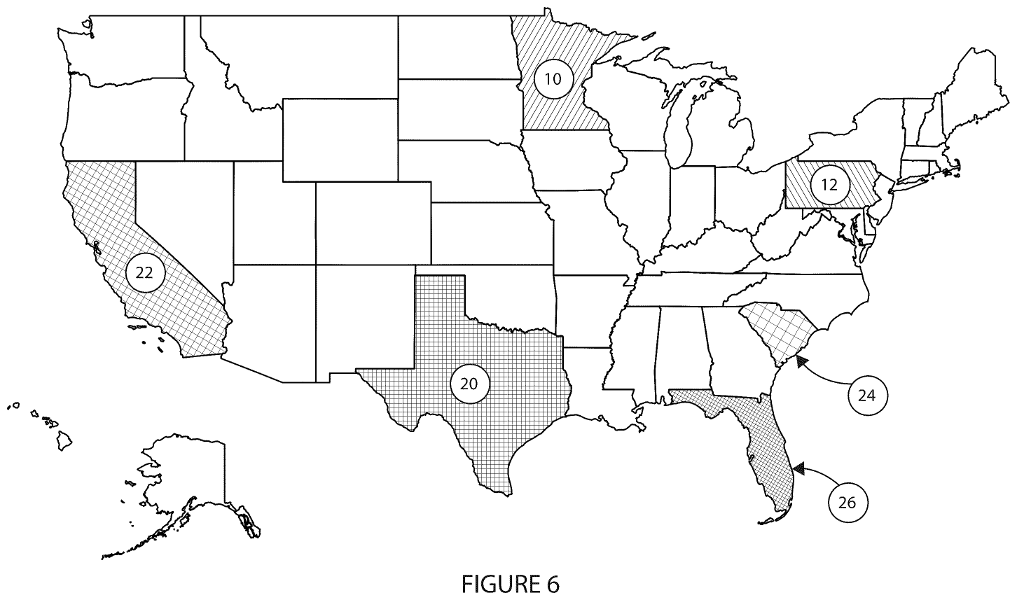

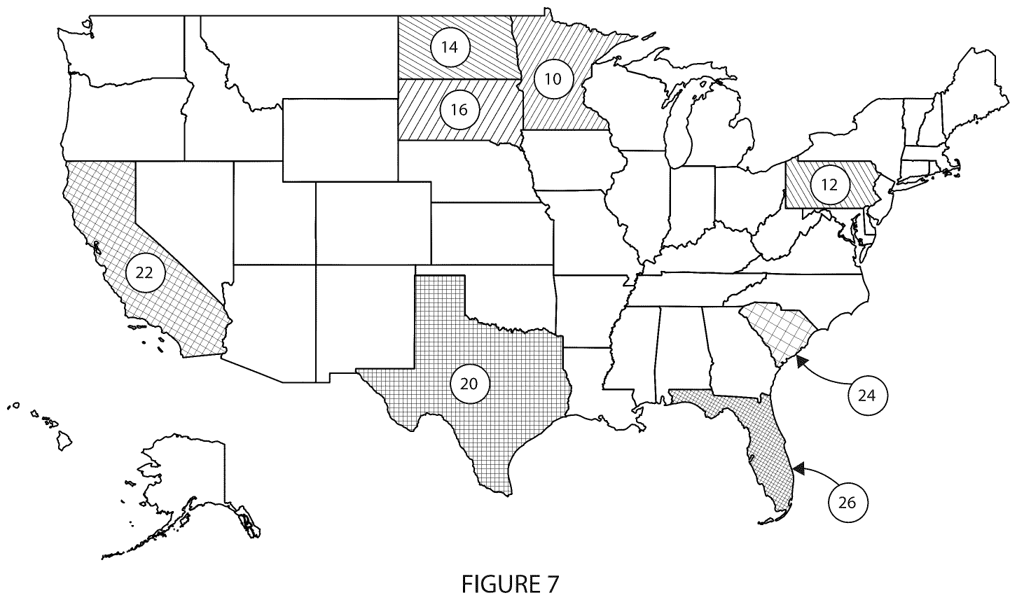

FIG. 6 is a map of the United States showing lottery participation options for an example implementation of the current disclosure showing another embodiment where person could participate in lotteries in the state of Minnesota 10, state of Pennsylvania 12, state of South Carolina 24, state of Florida 26, as well as the states of Texas 20 and California 22. There can be various combinations of locations of organizers and participants in the various states. FIG. 7 is a map of the United States showing lottery participation options for an example implementation of the current disclosure, showing additional states North Dakota 14 and South Dakota 16 that can be locations for lottery participation in the other states.

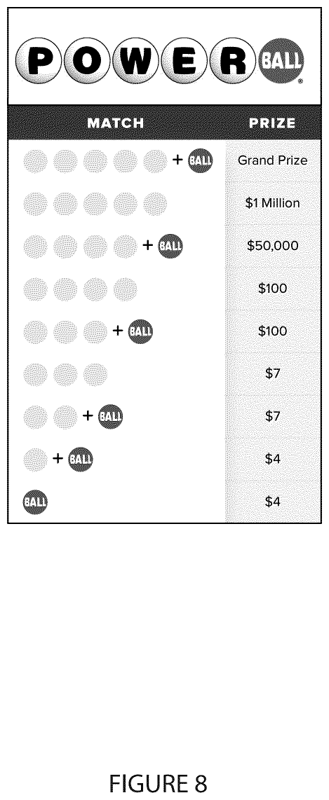

FIG. 8 is an illustration showing an example lottery ticket, in this case a Powerball ticket showing how there are different values of prizes depending upon the balls drawn. As described herein, the prizes can be divided up between organizer and participant depending upon the type of win (and amount). For example, all of the small prizes could go to the organizer and the large prizes could go to the participant.

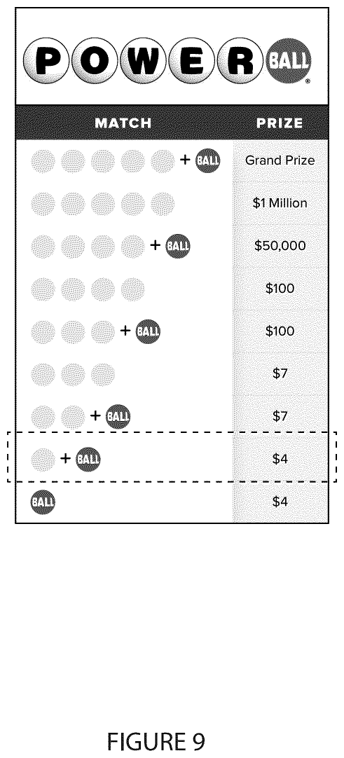

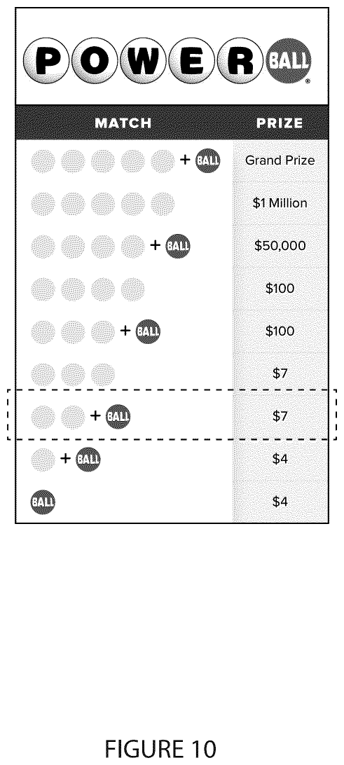

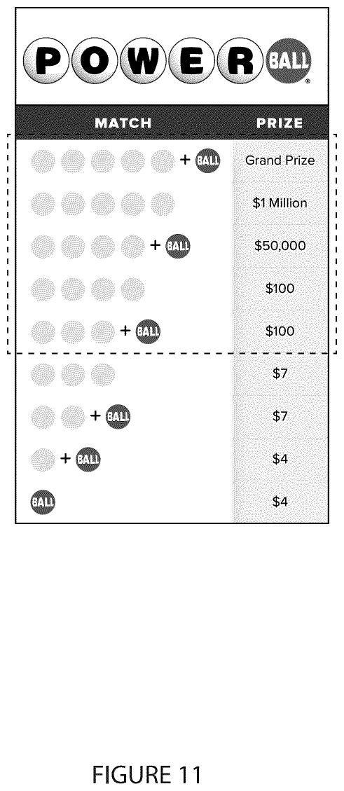

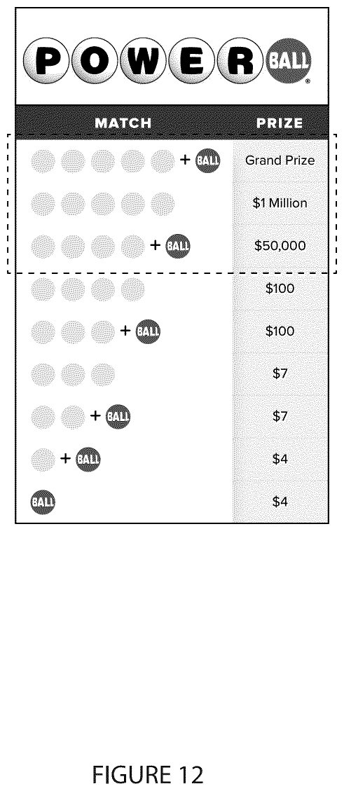

FIG. 9 is an illustration showing an example lottery ticket, in this case a Powerball ticket, showing a first distribution option for lottery proceeds such as where all wins that are at least one matching ball and the PowerBall go to the participant, but everything lower goes to the organizer (as an example). FIG. 10 is an illustration showing an example lottery ticket, in this case a Powerball ticket, showing a second distribution option for lottery proceeds where all wins that are at least two matching balls and the PowerBall go to the organizer and higher awards go to the participant. FIG. 11 is an illustration showing an example lottery ticket, in this case a Powerball ticket, showing a further distribution option for lottery proceeds, with the highest amounts (say $100) going to the participant. These various combinations will often align with how much of a contribution is made by each of the organizer and participant to purchase the lottery ticket. For example, the participant can be willing to accept only the larger payouts in exchange for either a larger contribution from the organizer or in consideration of the benefits of wider purchase options and ease of use. FIG. 12 is an additional alternative where four balls plus PowerBall goes to the participant, so greater than $50,000 prizes (in this embodiment).

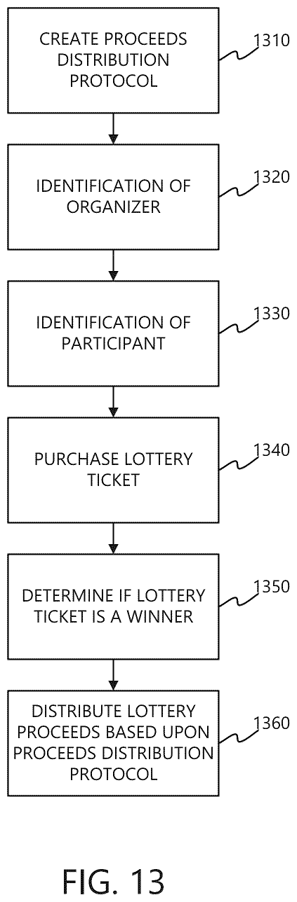

FIG. 13 is a flow chart showing example steps of a method for distributing lottery proceeds in accordance with the present disclosure. The steps including creating a proceeds distribution protocol 1310, identification of an organizer 1320, identification of a participant 1330 (optional taking place before identification of an organizer 1320), purchase of a lottery ticket 1340; determining if the lottery ticket is a winner 1350; and then distributing lottery proceeds based upon a proceeds distribution protocol. It will be appreciated that the order of some steps can be changed without deviating from the scope of the disclosure and claims herein.

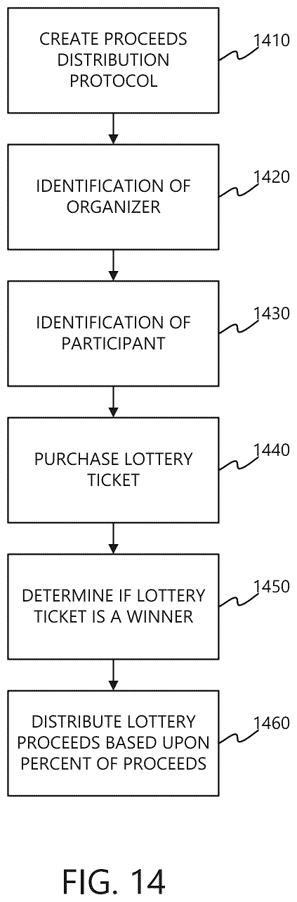

FIG. 14 is a flow chart showing example steps of a method for distributing lottery proceeds in accordance with the present disclosure. The steps include creating a proceeds distribution protocol 1410; identification of an organizer 1420; identification of a participant 1430; purchase of a lottery ticket 1440; determining if a lottery ticket is a winner 1450; and distribution of lottery proceeds based upon percent of proceeds 1460. It will be appreciated that the order of some steps can be changed without deviating from the scope of the disclosure and claims herein.

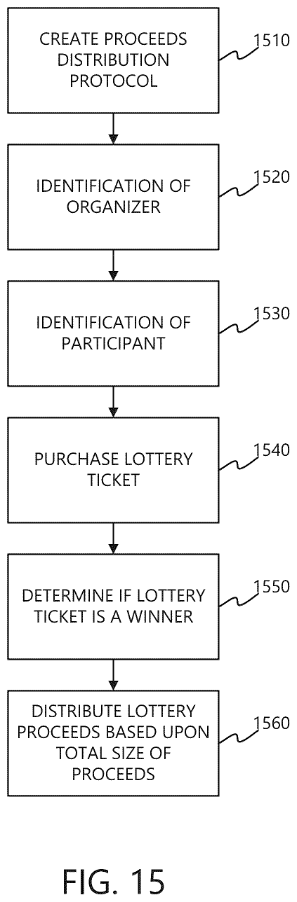

FIG. 15 is a flow chart showing example steps of a method for distributing lottery proceeds in accordance with the present disclosure. The steps include creating a proceeds distribution protocol 1510; identification of an organizer 1520; identification of a participant 1530; purchase of a lottery ticket 1540; determining if a lottery ticket is a winner 1550; and distribution of lottery proceeds based upon total size of proceeds 1560. It will be appreciated that the order of some steps can be changed without deviating from the scope of the disclosure and claims herein.

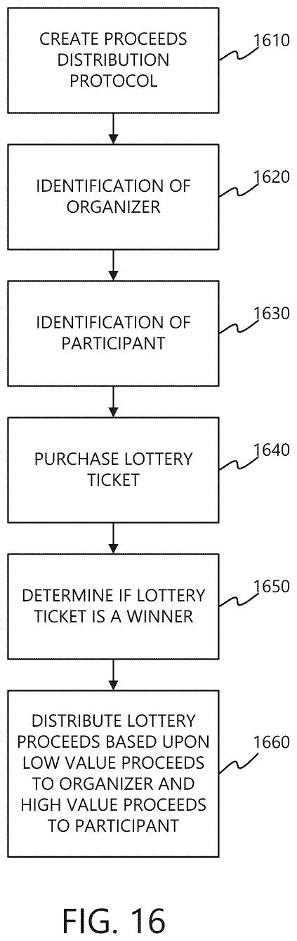

FIG. 16 is a flow chart showing example steps of a method for distributing lottery proceeds in accordance with the present disclosure. The steps include creating a proceeds distribution protocol 1610; identification of an organizer 1620; identification of a participant 1630; purchase of a lottery ticket 1640; determining if a lottery ticket is a winner 1650; and distribution of lottery proceeds based upon low value proceeds going to the organizer and high value proceeds going to the participant 1660. It will be appreciated that the order of some steps can be changed without deviating from the scope of the disclosure and claims herein.

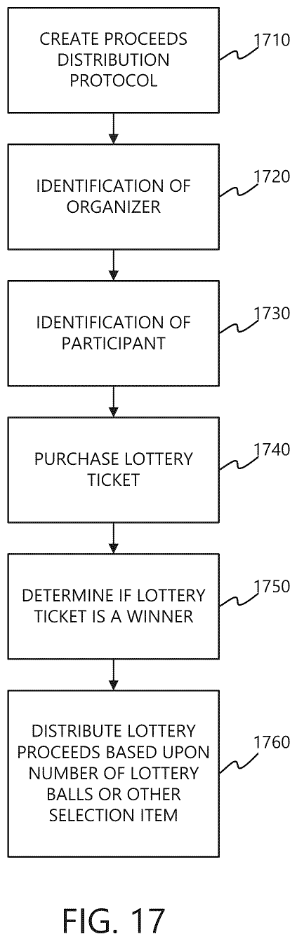

FIG. 17 is a flow chart showing example steps of a method for distributing lottery proceeds in accordance with the present disclosure. The steps include creating a proceeds distribution protocol 1710; identification of an organizer 1720; identification of a participant 1730; purchase of a lottery ticket 1470; determining if a lottery ticket is a winner 1750; and distribution of lottery proceeds based upon the number of lottery balls or other selection item 1760. It will be appreciated that the order of some steps can be changed without deviating from the scope of the disclosure and claims herein.

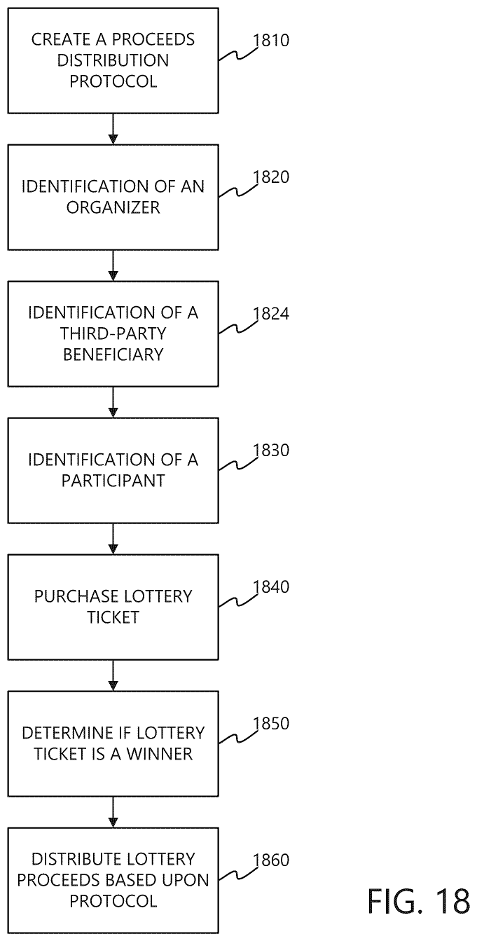

FIG. 18 is a flow chart showing example steps of a method for distributing lottery proceeds in accordance with the present disclosure. The steps include creating a proceeds distribution protocol 1810; identification of an organizer 1820; identification of a third-party beneficiary 1824; identification of a participant 1830; purchase of a lottery ticket 1840; determination if a lottery ticket is a winner 1850; and distribution lottery proceeds based upon a protocol 1860. It will be appreciated that the order of some steps can be changed without deviating from the scope of the disclosure and claims herein.

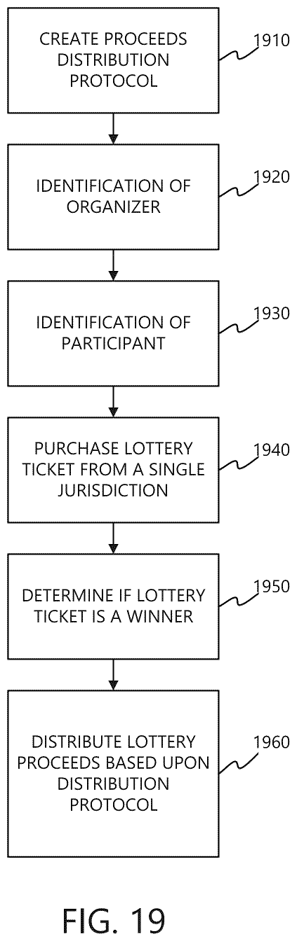

FIG. 19 is a flow chart showing example steps of a method for distributing lottery proceeds in accordance with the present disclosure. The steps include creating a proceeds distribution protocol 1910; identification of an organizer 1920; identification of a participant 1930; purchase of a lottery ticket from a single jurisdiction 1940; determination if the lottery ticket is a winner 1950; and distributing lottery proceeds based upon a distribution protocol 1960. It will be appreciated that the order of some steps can be changed without deviating from the scope of the disclosure and claims herein.

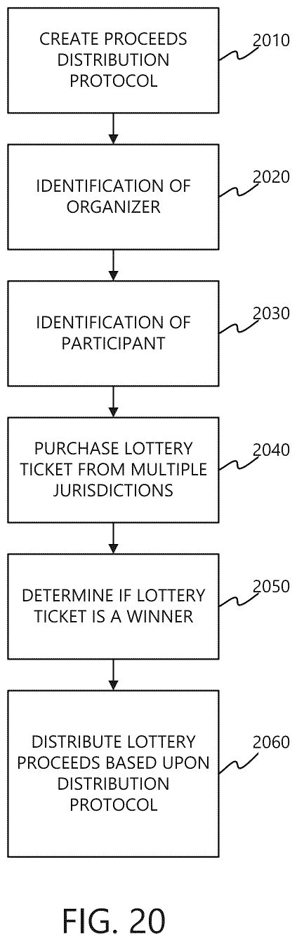

FIG. 20 is a flow chart showing example steps of a method for distributing lottery proceeds in accordance with the present disclosure. The steps can include creating a proceeds distribution protocol 2020; identification of an organizer 2020; identification of a participant 2030; purchase of a lottery ticket from multiple jurisdictions 2040; determination if the lottery ticket is a winner 2050; and then distribution of the lottery proceeds based upon a distribution protocol 2060. It will be appreciated that the order of some steps can be changed without deviating from the scope of the disclosure and claims herein.

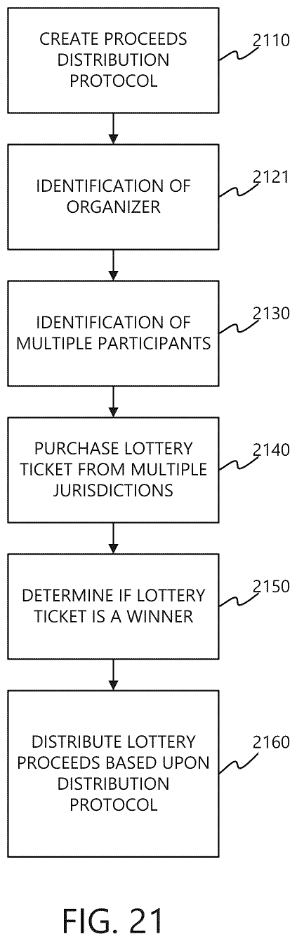

FIG. 21 is a flow chart showing example steps of a method for distributing lottery proceeds in accordance with the present disclosure. The steps include creating a proceeds distribution protocol 2110; identification of an organizer 2121; identification of multiple participants 2130; purchase of a lottery ticket from multiple jurisdictions 2140; determination if the lottery ticket (or tickets) is a winner 2150; and then distributing the lottery proceeds based upon a distribution protocol 2160. It will be appreciated that the order of some steps can be changed without deviating from the scope of the disclosure and claims herein.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method for distributing lottery proceeds, the method comprising:
creating an agreed upon lottery proceeds distribution protocol for dividing lottery proceeds between an organizer and a participant;
identification of an organizer;
identification of a participant;
purchasing at least one lottery ticket in advance of a lottery drawing;
determining if the lottery ticket has been a winner and the amount of the lottery proceeds; and
distributing the lottery proceeds based upon the distribution protocol;
wherein the participant receives a pre-determined portion of the lottery proceeds.

2. The method for distributing lottery proceeds of claim 1, wherein the organizer receives a preset percent of the lottery proceeds.

3. The method for distributing lottery proceeds of claim 1, wherein the participant receives a preset percent of all proceeds.

4. The method for distributing lottery proceeds of claim 1, wherein the distribution is based upon the total size of the lottery proceeds.

5. The method for distributing lottery proceeds of claim 4, wherein the organizer receives all proceeds below two dollars.

6. The method for distributing lottery proceeds of claim 4, wherein the organizer receives all proceeds below three dollars.

7. The method for distributing lottery proceeds of claim 4, wherein the organizer receives all proceeds below four dollars.

8.-18. (canceled)

19. The method for distributing lottery proceeds of claim 1, wherein the lottery participants are from a single lottery jurisdiction.

20. The method for distributing lottery proceeds of claim 1, wherein the lottery participants are from multiple lottery jurisdictions.

21.-32. (canceled)

33. A method for distributing lottery proceeds, the method comprising:
creating an agreed upon lottery proceeds distribution protocol for dividing lottery proceeds between an organizer and a participant;
identification of an organizer;
identification of a third party beneficiary;
identification of a participant;
purchasing at least one lottery ticket in advance of a lottery drawing;
determining if the lottery ticket has been a winner and the amount of the lottery proceeds; and
distributing the lottery proceeds based upon the distribution protocol;
wherein the third-party beneficiary receives a pre-determined portion of the lottery proceeds and the participant receives the remainder of the proceeds.

34. The method for distributing lottery proceeds of claim 33, wherein the organizer receives a preset percent of the lottery proceeds.

35. The method for distributing lottery proceeds of claim 33, wherein the participant receives a preset percent of all proceeds.

36. The method for distributing lottery proceeds of claim 33, wherein the distribution is based upon the total size of the lottery proceeds.

37. The method for distributing lottery proceeds of claim 36, wherein the third-party beneficiary receives all proceeds below two dollars.

38. The method for distributing lottery proceeds of claim 36, wherein the third-party beneficiary receives all proceeds below three dollars.

39. The method for distributing lottery proceeds of claim 36, wherein the third-party beneficiary receives all proceeds below four dollars.

40.-57. (canceled)

58. A method for distributing lottery proceeds, the method comprising:
creating an agreed upon lottery proceeds distribution protocol for dividing lottery proceeds between an organizer and a participant;
identification of an organizer;
identification of at least one participant
purchasing a plurality of lottery tickets in advance of a lottery drawing;
determining if the lottery tickets include winner and the amount of the lottery proceeds; and
distributing the lottery proceeds based upon the distribution protocol;
wherein the participants receive a pre-determined portion of the lottery proceeds.

59. The method for distributing lottery proceeds of claim 58, wherein the organizer receives a preset percent of the lottery proceeds.

60. The method for distributing lottery proceeds of claim 58, wherein the participants receive a preset percent of all proceeds.

61.-117. (canceled)
